(19) United States
(12) Patent Application Publication
(10) Pub. No.: US 2012/0171552 A1
(43) Pub. Date: Jul. 5, 2012

(54) BATTERY MODULE

(75) Inventors: Walter Lachenmeier, Sankt Augustin (DE); Tim Schaefer, Niedersachswerfen (DE); Andreas Gutsch, Luedinghausen (DE)

(73) Assignee: LI-TEC BATTERY GMBH, Kamenz (DE)

(21) Appl. No.: 13/146,680

(22) PCT Filed: Jan. 21, 2010
(86) PCT No.: PCT/EP10/00355

§ 371 Date: Mar. 13, 2012

(30) Foreign Application Priority Data
Jan. 28, 2009 (DE) 10 2009 006 465.6

(51) Int. Cl. H01M 2/10; B21D 53/88

(52) U.S. Cl. 429/159; 29/897.2

(57) ABSTRACT

Battery module (1), comprising an electric cell (6), a module housing (2) which receives the electric cell (6), two or more, in particular four or six contacting units (4) which are attached to the module housing (2), wherein each of the contacting units (4) has at least two connections (5).

The invention relates to a battery module. Such battery modules are usually parts of a battery arrangement comprising multiple battery modules and are used for supplying power in particular to electrically powered vehicles. Such a battery module comprises an electric cell, which generally consists of a galvanic cell. The battery module thus has application in primary batteries, that is, non-rechargeable batteries, and in secondary batteries, that is, rechargeable batteries.

From DE 32 46 968 C2 an electric battery is known with multiple cells placed side by side, arranged in parallel to one another. The electrical cells are connected to each other on their two sides by electrical contact arrangements, on which contact paths are located. Such a contact arrangement is constructed as an insulating plate with contact paths in the form of a printed circuit.

DE 103 18 587 B4 discloses a device for the connection of electrical cells. The device comprises a housing for holding electrical cells and a plug and socket connecting plate with a plurality of holes. A plug-in connecting plate is further provided, which is fitted with a plurality of projections. The projections are inserted into the holes of the plug and socket connecting plate, wherein the projections electrically connect die electrical cells together, in a particular configuration.

The object of the present invention is to provide an improved battery module and an improved battery arrangement.

The object addressed by the invention is achieved by a battery module comprising an electric cell, a module housing which receives the electric cell, two or more, in particular four or six contacting units which are attached to the module housing, wherein each of the contacting units has at least two connections.

Due to the fact that at least two contacting units are provided which each have at least two connections, at least four connections are therefore present. This means that the battery module can be connected to a battery module that is connected upstream on the one hand, and on the other hand, a further downstream battery module can be connected to the battery module. The contacting units of adjacent battery modules can thus be arranged spatially directly adjacent to one another. Wiring that is required for spanning a spatial distance can be dispensed with. Electric cell is understood to mean, in particular, primary and secondary batteries, but also fuel cells. Therefore, the term battery module also includes a module which receives one or more fuel cells.

Preferably every contacting unit has at least one positive pole connection and at least one negative pole connection. With the positive pole or negative pole connection of a first of at least two contacting units, the complete coupling of the battery module to an upstream battery module is facilitated. With the positive pole connection and the negative pole connection of another of the at least two contacting units, the battery module can be connected to a further battery module. Therefore many battery modules can be arranged adjacent to one another. Since the positive and negative pole connections of the battery modules can be arranged to be spatially directly adjoining one another, the electrical connection of the adjacent modules is simplified. Thus connections of the same type, that is to say, either positive pole connections or negative pole connections of adjacent battery modules can be brought into contact, which takes place in a parallel circuit arrangement of the electric cells. In addition, connections of different types, for example plus connection of the one battery module and minus pole connection of the other battery module, can also be connected together, which takes place in a series circuit arrangement of electric cells.

In a preferred configuration, each of two contacting units are attached opposite each other on an outer surface of the module housing. The opposite arrangement causes the contact connections of battery modules aligned adjacent to each other to be able to overlap. This means the battery modules can be arranged in a row one behind the other. The connections of adjacent battery modules thus directly adjoin one another, so that the connections are directly in contact in electrically conductive connection with one another. Alternatively the establishment of the contact can be produced by contact sleeves or contact bolts, wherein a contact sleeve or a contact bolt is inserted simultaneously in connections of both battery modules.

Preferably, the positive pole connections are in electrically conductive connection with the positive pole of the electric cell and the negative pole connections with the negative pole of the electric cell. Furthermore, connections of a battery module of the same type are preferably electrically conductively connected to each other. Further preferably, all of the connections of a battery module of the same type are electrically conductively connected to each other. All of the positive pole connections of a battery module are of the same type. All of the negative pole connections of a battery module are of the same type. Even if the positive pole connection is in electrical connection with the negative pole connection indirectly via the electric cell, this indirect connection does not represent an electrically conductive connection in the sense of the above description.

For a particularly versatile application, connections of two contacting units are arranged opposite one another. This enables a connection of an adjacent battery module to abut against a corresponding opposite connection of another battery module device and to come into contact therewith. In this case it is advantageous if connections of the same type are each arranged on opposite outer surfaces in mirror-inverted fashion. To judge whether the connections are arranged in mirror-inverted fashion on opposite outer surfaces, the respective outer surfaces on which the connections are arranged must always be observed from the front.

Preferably, opposite contacting units are arranged on different outer surfaces, parallel to one another. This means that the modularity and the extensibility are enhanced, since a battery arrangement consisting of multiple battery modules can always be extended by a further battery module which is placed in contact with one of the parallel outer surfaces. This allows multiple battery modules to be arranged in a row one behind the other. If the battery module comprises four or six contacting units, the contacting units are arranged on different outer surfaces, each parallel and lying opposite one another. Therefore further battery modules can also be arranged to the side of a battery module. For this purpose the battery module preferably has a cuboid shape.

Specifically, the connections of a first contacting unit can be arranged mirror-inverted with respect to opposite connections of a second contacting unit that is opposite to the first contacting unit. To assess whether the connections are arranged in mirror-inverted fashion on opposite outer surfaces, the respective outer surface on which the connections are arranged must always be observed from the front.

Preferably a negative pole connection of the first contacting unit is arranged opposite a negative pole connection of the second contacting unit. In addition, a positive pole connection of the first contacting unit is preferably arranged opposite a positive pole connection of the second contacting unit. Due to the respectively opposite arrangement of pole connections of the same type, adjacent battery modules with their pole connections can in each case be placed in contact with the adjacent battery modules with their respective pole connections.

A contacting unit preferably comprises at least two positive pole connections and an opposite contacting unit at least two negative pole connections, wherein a positive pole connection of one of the contacting units is arranged opposite to a negative pole connection of the opposite contacting unit. This enables a battery module with the negative pole connection to be placed in contact with the positive pole connection of another battery module, when two battery modules adjoin each other. This is necessary for example to be able to easily implement a series connection of battery modules.

The connections can be formed in such a manner that opposite connections of adjacent battery modules can be connected together using connection means. One connection preferably comprises a through bore. The connection means can each be in the form of contact sleeves which can each be brought together with at least one connection to form a plug connection.

Preferably, the through bore can be constructed as a threaded through bore. Corresponding connection means can then be constructed as contact bolts, which can each be screwed to at least one connection. To allow this the connection has a threaded through bore.

In the through bore a contact spring is preferably arranged, which can apply a force to an inserted connection means for a frictionally engaged connection.

Preferably, the battery module has a cuboid shape. This means that multiple battery modules can be easily brought together in a planar space-saving arrangement. In addition, multiple battery modules can be arranged in a stack. Preferably the battery module has a contacting unit on each of four outer surfaces. Further preferably, the battery module has a contacting unit on each of six outer surfaces. The provision of four or, in particular, six outer surfaces with in each case one contacting unit, results in additional arrangement possibilities and thus a greater variability in the configuration of battery arrangements comprising multiple battery modules.

A connection is preferably arranged on an outer surface, wherein the outer surface comprises a groove which extends from the connection as far as an outer surface bordering the outer surface. This facilitates access to the connection, specifically from an outer surface other than the outer surface on which the relevant connection is arranged. This brings with it the advantage that connections from adjacent battery modules that are already in contact can be subsequently brought into electrically conducting connection with one another via connection means. The groove thus forms an access from the adjoining adjacent side surface, so that the two battery modules no longer need to be moved relative to each other for the installation of the connection means. Further, already installed connection means can be removed again without the battery modules needing to be moved relative to each other. The groove, when considered in cross-section, is no smaller than a connection means which is to be installed or de-installed.

A bevel is preferably provided between two outer surfaces, on which the contacting unit is arranged. This bevel facilitates a simplified installation of the connection means.

In a particularly preferred configuration a plurality of projections is provided on at least one outer surface. These projections serve as spacers between the outer surfaces of two adjacent battery modules. By means of the spacing thereby produced, space is created for a heat dissipation or a heat supply facility. The heat removal or the heat supply can be implemented via thermal conduction plates or by fluid media, such as cooling or heating fluids or by air cooling.

In a preferred configuration the contacting units comprise freely assignable connections, wherein freely assignable connections of different contacting units are electrically connected to one another. It is in particular advantageous if the contacting units comprise first freely assignable connections and second freely assignable connections, wherein the first freely assignable connections of different contacting units are electrically connected to one another and wherein the second freely assignable connections of different contacting units are electrically connected to one another. The freely assignable connections extend the plurality of the application possibilities, since the wiring of the battery modules can be configured in a more complex fashion, without requiring recourse to external contacting means such as cables or clamps.

For the case in which liquid heat conducting means are provided, it is advantageous if unneeded connections on outer surfaces of battery modules which come into contact with the liquid medium are sealed off by means of sealing plugs. This takes place preferably using sealing plugs which are configured or suitable for sealing connections of a contacting unit of a battery module of the above type. The problem addressed by the invention is further solved by a battery arrangement comprising multiple battery modules according to the type described above, wherein connections of adjacent battery modules are electrically conductively connected to each other.

The problem addressed by the invention is further solved by a method for assembling a motor vehicle, comprising the following method steps:
Attachment of components, in particular assemblies, hose connections and cables, to a unit of a vehicle;
Fixing of a first battery module of the aforementioned type onto the unit of the vehicle or onto a component;
Connection of further battery modules of the aforementioned type at least indirectly to the first battery module.

‘Indirectly’ in this context means that the battery modules are connected to the first battery module at least via the interposition of other battery modules. By this method, the space between the components in the vehicle compartment can be optimally used by the battery arrangement.

The invention will now be explained in further detail using the attached Figures. These show:

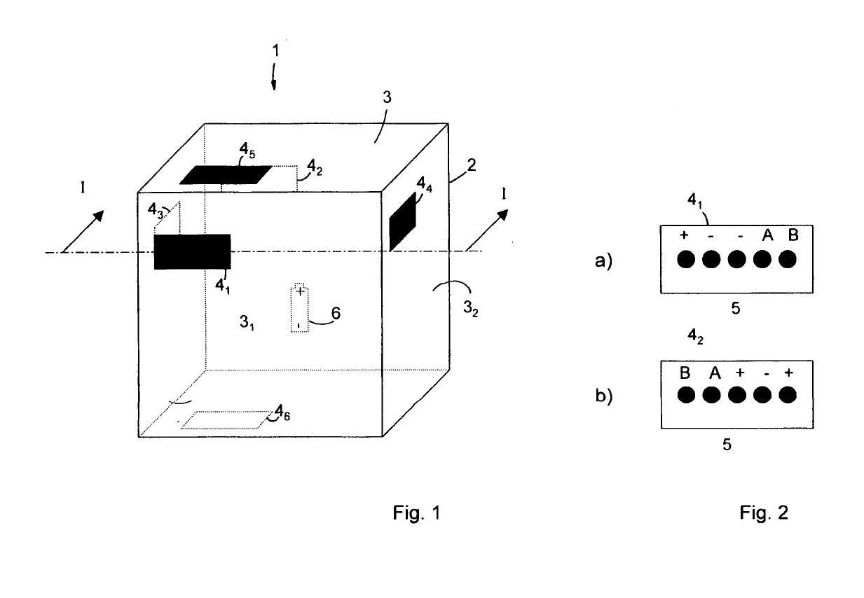

FIG. 1 a schematic illustration of a battery module according to the invention in perspective view,

FIG. 2 a) a first contacting unit and
b) a second contacting unit of the battery module according to FIG. 1 opposite to the first contacting unit, each comprising five connections;

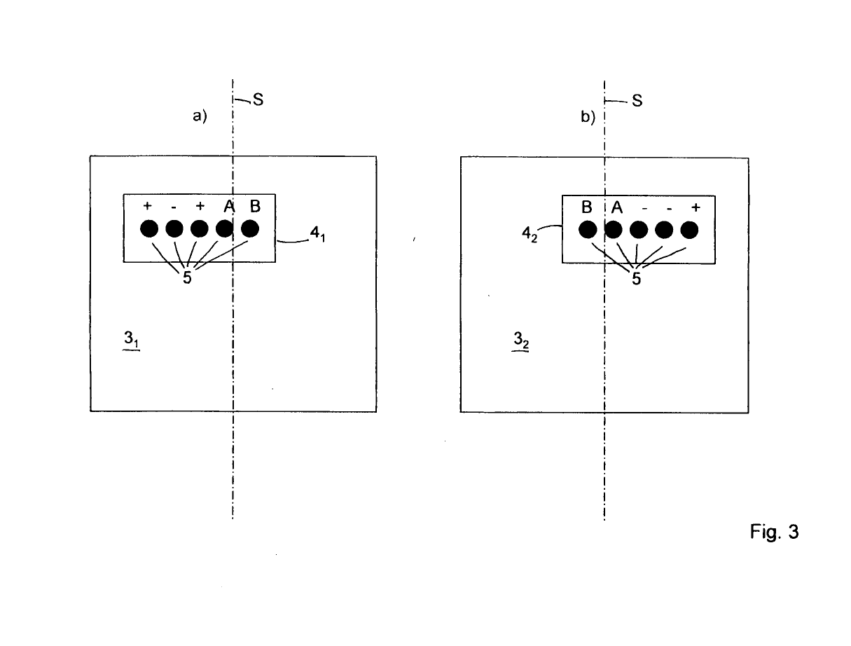

FIG. 3 the plan view of two opposite outer surfaces of the battery module according to FIG. 1, comprising in each case the first and the second contacting unit according to FIG. 2;

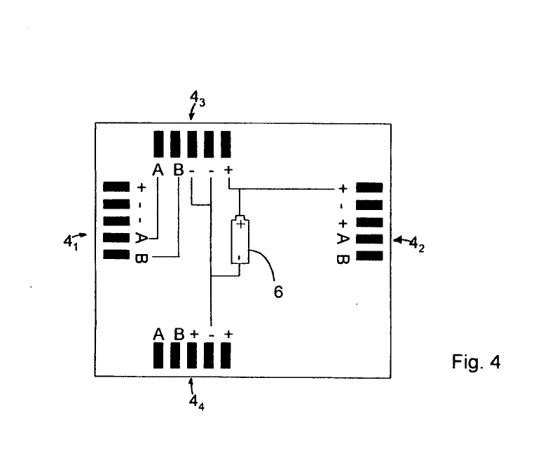

FIG. 4 schematically a cross-section through the battery module according to FIG. 1 along the cut line I-I;

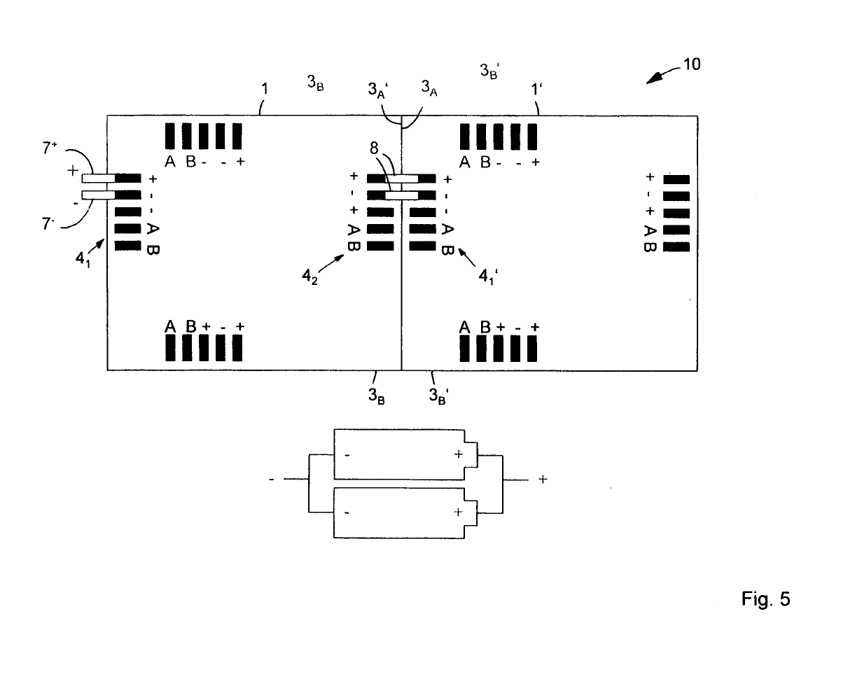

FIG. 5 a battery arrangement according to the invention comprising two battery modules according to the invention connected in parallel, with corresponding circuit diagram;

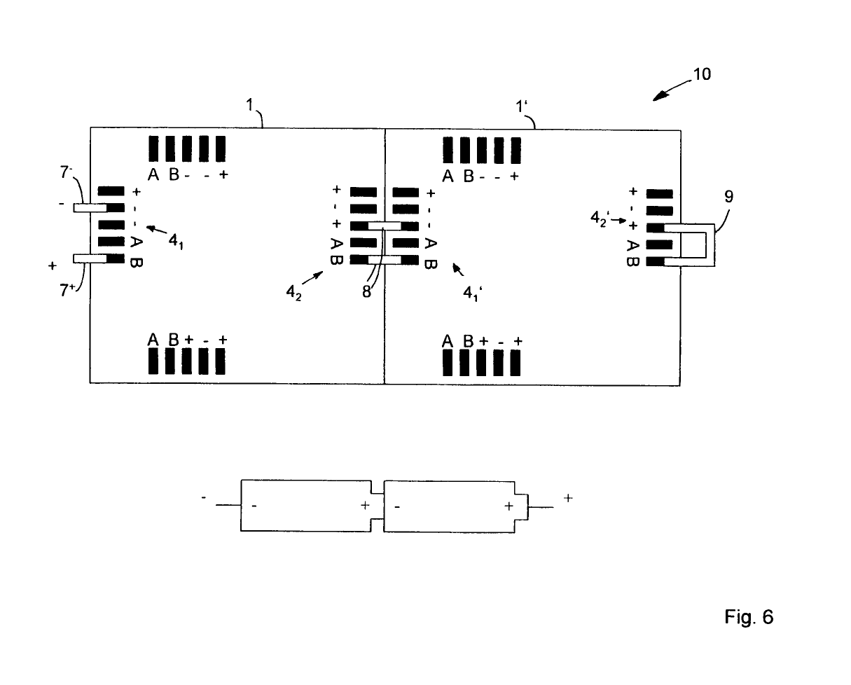

FIG. 6 a battery arrangement according to the invention comprising two battery modules according to the invention connected in series, with corresponding circuit diagram;

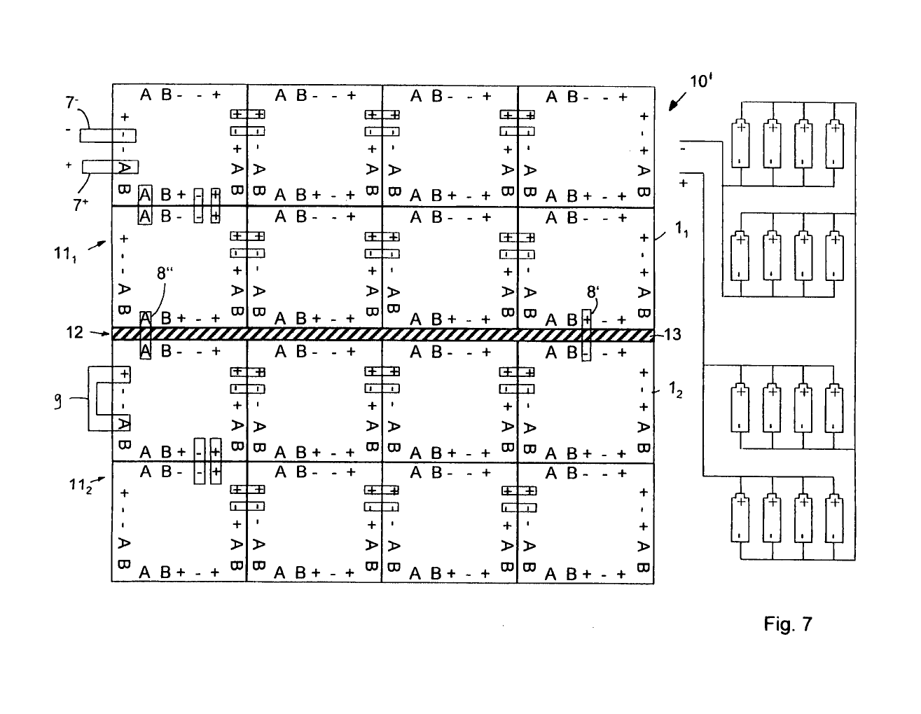

FIG. 7 a battery arrangement according to the invention comprising sixteen battery modules according to the invention in a combined series and parallel connection, with corresponding circuit diagram;

FIG. 8 a configuration of a battery module according to the invention in detail
a) in side view,
b) in cross-section;

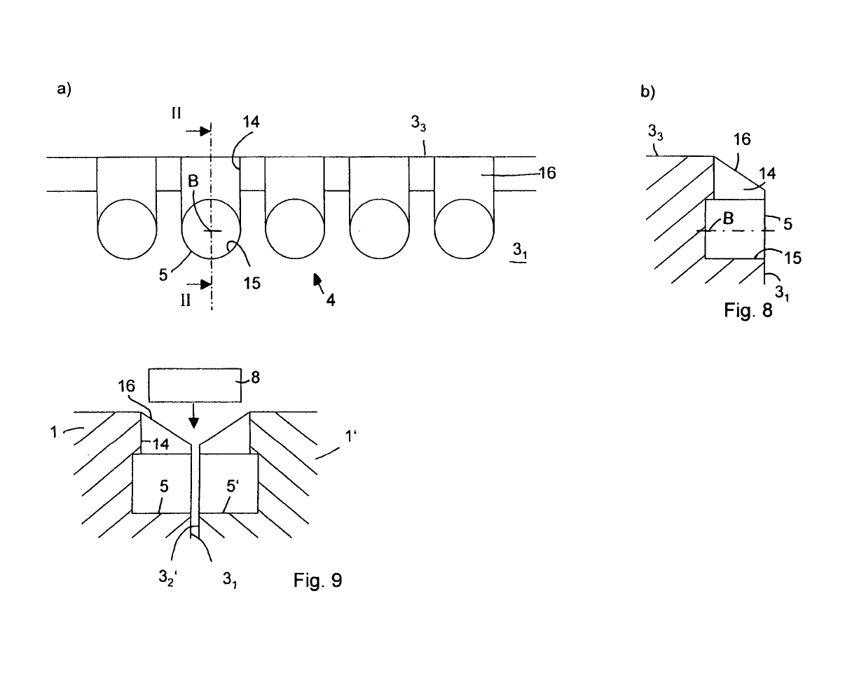

FIG. 9 two battery module according to the invention as specified in the configuration of FIG. 8;

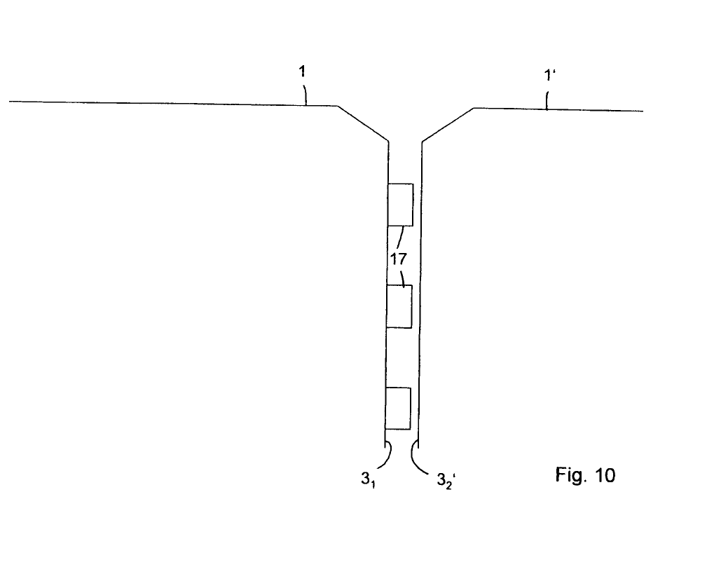

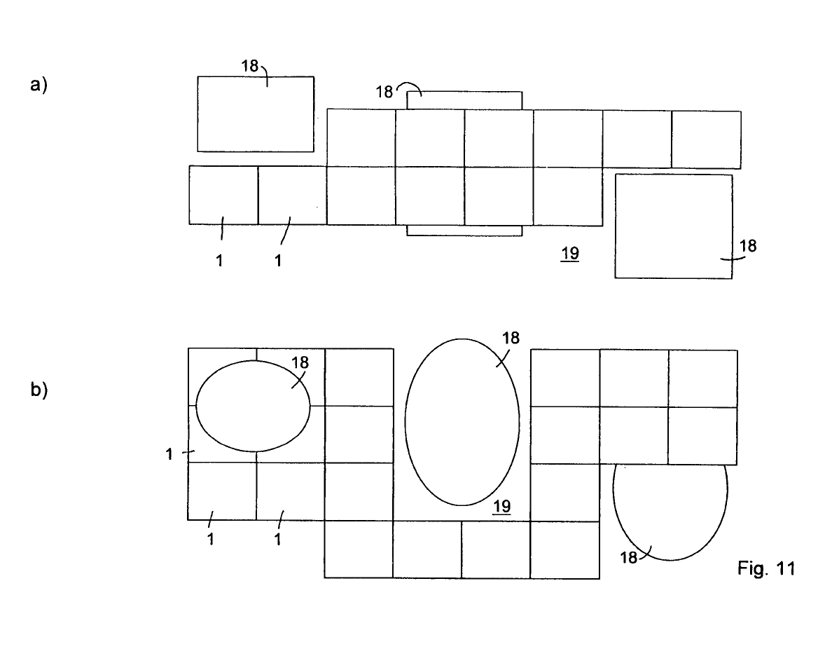

FIG. 10 two battery modules according to the invention with projections on an outer surface;

FIG. 11 a schematically illustrated excerpt from a vehicle engine compartment in which a battery arrangement according to the invention is mounted
a) in side view,
b) in plan view.

FIG. 1 illustrates a battery module 1 according to the invention, which is delimited by a rectangular module housing 2. The module housing shown comprises six outer surfaces 3. The outer surfaces 3 are all square in shape with in each case identical edge lengths, with the result that the battery module has a cubic shape overall.

On each of the six outer surfaces 3 a contacting unit 4 is arranged. Each contacting unit 4 comprises multiple connections 5, which represent an interface of the battery module 1, as is described in further detail below. The battery module 1 shown in FIG. 1 comprises altogether six contacting units 4, wherein exactly one contacting unit 4 is arranged on each of the outer surfaces 3. The contacting units, which in FIG. 1 are hidden by the battery module itself, are indicated by dashed lines.

Representing the altogether six contacting units 4 in FIG. 2, two contacting units 4 can be identified in detail. In FIG. 2a the contacting element 4₁ can be identified, which is arranged on the outer surface 3₁, which in FIG. 1 can be seen from the front. FIG. 2b shows the contacting unit 4₂ which is arranged on the rear side of the battery module 1 shown in FIG. 1.

The contacting unit 4₁ comprises altogether five connections 5, which viewed from left to right have the following specifications: one positive pole connection, two negative pole connections, a first freely assignable connection A, a second freely assignable connection B. The contacting unit 4₂ also comprises five connections, which viewed from left to right have the following specifications. A second freely assignable connection B, a first freely assignable connection A, one positive pole connection, one negative pole connection, one positive pole connection. The positive pole connections of the contacting units are each electrically conductively connected to a positive pole of the electric cell 6 positioned in the battery module 1. The electrical cell 6 is only indicated schematically. The negative pole connections of the contacting units are each electrically conductively connected to a negative pole of the electric cell 6. The freely assignable connections A and B are not connected to the electric cell 6, but are only connected among one another to connections of the same type. Thus, the freely assignable connection A of the contacting unit 4₁ is connected to the freely assignable connection A of the contacting unit 4₂. The same applies to the freely assignable connection B of the contacting unit 4₁, which is connected to the freely assignable connection B of the contacting unit 4₂. The freely assignable connections moreover, are also electrically conductively connected to the respective connections of the same type of the remaining contacting units 4₃ to 4₆. The electrical cell 6 is designed as a secondary battery.

It is additionally clearly visible in FIG. 2 that the connections of the first contacting unit 4₁ are essentially mirror-inverted with respect to the connections of the contacting unit 4₂, with the exception of the central connection. This mirror-inverted arrangement is provided so that, in particular, similar connections of adjacent battery modules adjoining one another can be brought into contact with one another, which will be explained in further detail below. The mirror-inverted arrangement always relates to contacting units that are opposite one another.

In FIG. 3, the outer surface 3₁, representing all outer surfaces, and the respectively opposite outer surface 32 are shown. The contacting units 4₁ and 4₂ are arranged off-centre on these outer surfaces 3₁, 3₂. It can be seen that the contacting units are arranged essentially in a mirror-inverted fashion on the respective outer surfaces 3₁, 3₂, wherein the mirror-inversion takes place in each case relative to an imaginary inversion axis S, which extends centrally through the outer surfaces 3₁, 3₂. It is thus possible that the contacting units of two adjacent battery modules 1, which are in contact with each other, adjoin each other so that they are flush.

FIG. 4 shows a sectional view through the battery module 1 according to FIG. 1, wherein the connections 5 of the contacting units 4₁, 4₂, 4₃ and 4₄ can be identified. For ease of illustration the contacting units shown here are arranged within a common plane. Contacting units which are not opposite one another can also readily be arranged in different planes. In FIG. 4 the internally positioned schematic electric cell 6 can be identified. For exemplification, several electrical connections are shown between the battery connections both among themselves and with the electric cell. Thus for example it can be seen that the positive pole connection of the contacting unit 4₃ is connected to the positive pole connection of the electrical cell and the contacting unit 4₂. Obviously, the positive pole connection of the contacting unit is also connected to the positive pole connections of the other contacting units 4₁, 4₄, 4₅ and 4₆ of the battery module 1. The same applies for the negative pole connections of the contacting units, which are all connected to one another and to the negative pole connection of the electric cell 6. The freely assignable connections A are each connected to one another. Likewise, the freely assignable connections B are all connected to one another.

FIG. 5 shows a battery arrangement 10, which altogether comprises two battery modules 1, 1′. The battery modules are in each case in mutual contact with two outer surfaces 3_{A}, 3_{A}′. The battery modules 1, 1′ are aligned flush with one another, so that other outer surfaces 3_{B}, 3_{B}′ of the battery modules 1, 1′ are flush with one another.

A pole shoe 7⁺, 7⁻ is attached to each of the positive pole connection of the contacting unit 4₁ of the first battery module 1 and the negative pole connection of the contacting unit 41 of the first battery module 1. The pole shoes can be designed either as a sleeves or as bolts, and can be plugged or screwed into the respective connection 5. Externally the respective pole shoe 7 represents then positive or negative pole of the battery arrangement 10 respectively.

It can be further seen that between each of the contacting units 4₂ of the first battery module 1 and the contacting unit 4₁′ of the second battery module 1′ a connecting sleeve 8 is arranged, which can also alternatively be configured as a threaded connecting bolt. The connecting sleeve 8 represents the electrically conducting connection between the positive pole connection of the contacting unit of the first battery module 1 and the positive pole connection of the contacting unit 4₁′ of the second battery module 1′. This wiring of the two battery modules 1, 1′ results in a parallel connection of the battery modules 1, 1′, as can be seen in simplified form from the circuit diagram shown below it.

FIG. 6 shows the battery arrangement 10 of FIG. 5 with a different circuit wiring. Here, only the differences relative to the wiring according to FIG. 5 are discussed. In the remaining respects the arrangements shown are equivalent.

It can be seen that, unlike the arrangement shown in FIG. 5, the pole shoe 7⁺ on the first battery module 1 is plugged into the freely assignable connection B. In addition, the freely assignable connections B of the contacting units 42 of the first battery module 1 and 4₁′ of the second battery module 1′ are connected together by means of a connecting sleeve 8. In addition, the central connections of the contacting unit 4₂ of the first battery module 1 and the contacting unit 4₁′ of the second battery module 1′ are connected together. Thus, the negative pole connection of the second battery module 1′ is connected to the positive pole connection of the first battery module 1. The positive pole connection of the second contacting unit 4₂′ of the second battery module 1′ is directly connected by means of a U-connector 9 to the freely assignable connection B of the contacting unit 4₂′ of the second battery module 1′. The positive pole shoe 7⁺ is therefore directly electrically conductively connected to the positive pole connection of the second contacting unit 4₂′ of the second battery module 1′. This produces a series connection between the two battery modules 1, 1′ as can be seen from the circuit diagram shown below it.

FIG. 7 shows a further battery arrangement 10′ comprising altogether sixteen battery modules 1. The battery modules 1 are combined into a total of two groups 11₁, 11₂ each consisting of eight battery modules 1. All positive pole connections and all negative pole connections of all battery modules 1 of a group 11₁, 11₂ are in each case, at least indirectly, electrically conductively connected to one another via connecting sleeves 8. Via a further connecting sleeve 8′, one positive pole connection of a battery module 1₁ of the one group 11₁ is electrically conductively connected to the negative pole connection of a battery module 1₂ of the other group 11₂. One negative pole shoe T is connected to a negative pole connection of a battery module 11 of the one group 111. One positive pole shoe 7⁺ is electrically conductively connected to the positive pole connection of a battery module 1₂ of the other group 11₂. The positive pole shoe 7⁺ is thus located on a freely assignable connection A in the same contacting unit 4 on which the negative pole shoe 7⁻ is also arranged, with the result that the external contacting of the entire battery arrangement 10 is effected at a single contacting unit. In order to still be able to make the electrically conductive connection between the positive pole shoe 7⁺ and the positive pole connection of the battery module 1₂, connecting sleeves 8″ are provided, which electrically connect together adjacent battery modules 1₁, 1₂ at their freely assignable connections A. On a battery module 12 of the second group 11₂ a U-connector 9 is provided between the positive pole connection and the freely assignable connection A in order to bring the positive pole connections of all battery modules 12 of the second group 11₂ into electrically conducting connection with the freely assignable connection A.

Overall, this results in a parallel circuit connection among the battery modules 1, of the respective groups 11₁, 11₂. The two groups 11₁, 11₂ are thus connected one after another in series. Overall, this results in the accompanying circuit diagram of the battery 10.

The two groups 11₁, 11₂ are arranged in FIG. 7 in a plane. It is obvious however, that each of the groups can be arranged relative to one another or geometrically in completely different ways. The connecting sleeves 8′ and 8″, which make the electrically conducting connection between the two groups 11, 11′, can then also be attached to contacting units on top surfaces or base surfaces of battery modules.

Between two groups 11₁, 11₂ of battery modules 11, 12 a gap is provided. This gap 12 serves to remove or supply heat. For efficient supply or dissipation of heat, a thermal conduction plate 13 is arranged in the gap 12. Alternatively, a thermally conducting medium, in particular a thermally conducting gas or a thermally conducting liquid, can also be arranged in the gap 12 or can permeate the gap.

In the case where a flow-capable thermally conducting medium is provided, which has an electrical conductivity, unneeded connections which may come into contact with the medium are sealed off by means of sealing plugs, not shown.

FIG. 8 shows the connections 5 of a contacting unit 4 of a battery module 1 in detail. FIG. 8b shows a sectional view along the cut line II-II of FIG. 8a. The contacting unit 4 is arranged on a first outer surface 31 of the battery module 1. The contacting unit 4 is arranged on a peripheral region of the outer surface 3₁, i.e. it is located near to an edge of the battery module 1, which in this case is cubic in shape. The connections 5 are each in the form of a through bore 15. In each case a groove 14 connects a through bore 15 to another outer surface 3₃ of the module housing 2. The two outer surfaces 3₁ and 3₃ therefore adjoin each other. The groove 14 extends perpendicular to a bore axis B of the through bore 15. The length of the groove, viewed along the longitudinal direction towards the bore axis B, essentially corresponds to half a length of a connecting sleeve 8 which is used for connecting two adjacent connections 5. Preferably however, the groove is slightly longer than half the length of the connecting sleeve 8, which allows an easier mounting of the contact sleeve.

In FIG. 9 two battery modules 1, 1′ can be seen, each shown in details analogously to the illustration according to FIG. 8b. Two connections 5, 5′ of the two battery modules 1, 1′ directly adjoin each other. Solely to provide a clearer illustration, the two surfaces 3₁, 3₂′ are shown a small distance apart from each other. A connecting sleeve 8 can now, after being passed through the grooves 14 of the battery modules, be inserted into the through bores 15. This therefore makes it possible to mount the connecting sleeve even if both battery modules 1, 1′ and the respective connections 5, 5′ already adjoin each other. To simplify the installation, the battery module 1 has a bevel 16, arranged in the bounding region between the two outer surfaces 3₁, 3₃, as can be seen in particular from FIG. 8b. This bevel facilitates a better access to the connections, for example by means of an external tool.

FIG. 10 shows the outer surface 3₁ of a battery module 1 in an advantageous configuration. The outer surface 3₁ comprises multiple projections 17, which protrude externally from the outer surface 3₁. The projections 17 serve as spacers to another battery module to be arranged adjacent thereto. The distance thereby generated between two battery modules facilitates an improved heat dissipation or supply. The projections themselves can be used as cooling fins. Solely to provide a clearer illustration, the surface 3₂′ is shown a small distance away from the projections 17.

It can be seen that the battery modules according to the invention can be used for battery arrangements of the most diverse configurations. In particular, the battery modules can be attached in the most diverse geometric arrangements. This means that the typical bulky block format of conventional battery units no longer applies and is replaced with a flexible modular system, which also allows small irregularly sized construction spaces in the vehicle to be exploited, as is shown by means of FIG. 11.

FIG. 11 shows schematically a detail of an engine compartment 19 of a motor vehicle. Reference label 18 is used to refer to various components that are located in the engine compartment 19. The components 18 can be any possible types of components that are arranged in an engine compartment, such as e.g. aggregates, chassis parts, hose connections or cables. The continuing development of automobiles leads to the fact that new components are constantly being introduced into the engine compartment or that some of the components already present require more space. This development is in conflicting relationship with the fact that the external dimensions of the vehicle must not exceed a certain maximum and the passenger compartment is intended to be as large as possible. One of the consequences of this is that the space requirements in the engine compartment of a vehicle are tight.

As well as the components 18, a plurality of battery modules 1 can be identified, which are chained together in an apparently random fashion. However, with the battery modules 1 the space available between the components 18 is utilised in an optimal way. In particular, the battery arrangement formed from the plurality of battery modules 1 is only assembled from the individual battery modules 1 at the final assembly stage of the vehicle. In this process, the individual components 18 are first mounted in the engine compartment 19.

Then, the battery modules 1 are arranged around the components 18 and joined together. At least one first battery module 1 is fixedly mounted in the engine compartment 19 wherein it is fixed onto a module of the vehicle or onto a component which is preferably already fixedly connected to the vehicle. Then, further battery modules 1 are mounted and at the same time at least indirectly connected to the first battery module.

### LIST OF REFERENCE MARKS

1 battery module
2 module housing
3 outer surface
4 contacting unit
5 connection
6 battery cell
7 pole shoe
8 connecting sleeve
9 U-connector
10 battery arrangement
11 group
12 gap
13 thermal conduction plate
14 groove
15 through bore
16 bevel
17 projection
B bore axis

1. A battery module (1), comprising
an electric cell (6),
a module housing (2), which receives the electric cell (6), and
two or more, in particular four or six contacting units (4) which are attached to the module housing (2),
wherein each of the contacting units (4) comprises at least two connections (5) each.

2. The battery module according to claim 1,
wherein
each contacting unit (4) comprises at least one positive pole connection (5) and at least one negative pole connection (5).

3. The battery module according to claim 2
wherein
in each case two contacting units (4) are attached opposite each other on an outer surface (3) of the module housing (2).

4. The battery module according to claim 3,
wherein
the positive pole connections (5) are in electrically conductive connection with the positive pole (5) of the electric cell (6) and the negative pole connections (5) with the negative pole of the electric cell (6).

5. The battery module according to claim 4,
wherein connections (5) of the same type are in electrically conductive connection with one another.

6. The battery module according to claim 5,
wherein
connections (5) of two contacting units (4) are opposite one another.

7. The battery module according to claim 6,
wherein connections (5) of the same type are arranged mirror-inverted on opposite outer surfaces (3), respectively.

8. The battery module according to claim 7,
wherein
opposite contacting units (4) are arranged on different outer surfaces (3), parallel to one another.

9. The battery module according to claim 8,
wherein
connections (5) of a first contacting unit (4) are arranged mirror-inverted with respect to opposite connections (5) of a second contacting unit (4) lying opposite the first contacting unit (4).

10. The battery module according to claim 9,
wherein
a negative pole connection (5) of the first contacting unit (41) is arranged opposite a negative pole connection (5) of the second contacting unit (42).

11. The battery module according to claim 10,
wherein
a positive pole connection (5) of the first contacting unit (41) is arranged opposite a positive pole connection (5) of the second contacting unit (42).

12. The battery module according to claim 11,
wherein
one contacting unit (4) has at least two positive pole connections (5) and an opposite contacting unit (4) has at least two negative pole connections (5), wherein one of the positive pole connections (5) of one of the contacting units (4) is arranged opposite a negative pole connection (5) of the opposite contacting unit (4).

13. The battery module according to claim 12,
wherein
connections (5) have a through bore (15), in particular a threaded through bore.

14. The battery module according to claim 13,
wherein
corresponding opposite connections (5) of adjacent battery modules (1) can be connected together by means of connection means (8).

15. The battery module according to claim 14,
wherein
the connection means (8) are in the form of contact bolts, each of which can be screwed to at least one connection (5).

16. The battery module according to claim 15,
wherein
the connection means are in the form of a contact sleeve (8), which can each be brought together with at least one connection (5) to form a plug connection.

17. The battery module according to claim 16,
wherein
the battery module (1) has a cuboid shape.

18. The battery module according to claim 17,
wherein
the battery module (1) comprises one contacting unit (4) on each of four outer surfaces (3).

19. The battery module according to claim 18,
wherein
the battery module (1) comprises one contacting unit (4) on each of six outer surfaces (3).

20. The battery module according to claim 19,
wherein
one connection (5) is arranged on an outer surface (3), wherein the outer surface (3) has a groove (14) which extends from the connection (5) as far as an outer surface (3) bordering the outer surface (3).

21. The battery module according to claim 20,
wherein
between two side surfaces (3), a bevel (16) is provided on which a contacting unit (4) is arranged.

22. The battery module according to claim 21,
wherein
a plurality of projections (17) are provided on at least one outer surface (3).

23. The battery module according to claim 22,
wherein
the contacting units comprise freely assignable connections, wherein freely assignable connections of different contacting units (4) are electrically connected to one another.

24. The battery module according to claim 23,
wherein
the contacting units (4) comprise first freely assignable connections and second freely assignable connections, wherein the first freely assignable connections of different contacting units (4) are electrically connected to one another and wherein the second freely assignable connections of different contacting units (4) are electrically connected to one another.

25. A sealing plug for sealing off a contacting unit of a battery module according to claim 1.

26. A battery unit comprising multiple battery modules according to claim 1,
wherein connections of adjacent battery modules are connected to one another by means of connection means (8).

27. A method Met-lied for assembling a motor vehicle, comprising:
attaching of components 18, in particular assemblies, hose connections and cables, to a unit of a vehicle;
attachment of a first battery module 1 according to claim 1 to the unit of the vehicle or to a component 18; and
connecting further battery modules 1 according to claim 1 at least indirectly to the first battery module.
